(19) United States
(12) Patent Application Publication
(10) Pub. No.: US 2021/0108523 A1
(43) Pub. Date: Apr. 15, 2021

(54) UNDUCTED SINGLE ROTOR ENGINE

(71) Applicant: General Electric Company, Schenectady, NY (US)

(72) Inventors: Brandon Wayne Miller, Liberty Township, OH (US); Andrew Breeze-Stringfellow, Montgomery, OH (US)

(21) Appl. No.: 17/071,019

(22) Filed: Oct. 15, 2020

Related U.S. Application Data
(60) Provisional application No. 62/915,364, filed on Oct. 15, 2019.

(51) Int. Cl. F01D 7/00

(52) U.S. Cl. CPC F01D 7/00; F05D 2240/12; F05D 2260/70

(57) ABSTRACT

A propulsion system according to aspects of the present disclosure is provided, the propulsion system including a rotor assembly with a plurality of blades extended radially relative to the engine centerline axis, and a vane assembly positioned in aerodynamic relationship with the rotor assembly. The vane assembly includes a plurality of vanes extended radially relative to the engine centerline axis, and the propulsion system includes a ratio of a quantity of blades to a quantity of vanes between 2:5 and 2:1.

### CROSS-REFERENCE TO RELATED APPLICATIONS

This application is a non-provisional application claiming the benefit of priority under 35 U.S.C. § 119(e) to U.S. Provisional Application No. 62/915,364, filed Oct. 15, 2019, which is hereby incorporated by reference in its entirety.

### FIELD

This application is generally directed to a turbomachine engine, including architectures for such an engine and methods for operating such an engine.

### BACKGROUND

A turbofan engine operates on the principle that a central gas turbine core drives a bypass fan, the bypass fan being located at a radial location between a nacelle of the engine and the engine core. With such a configuration, the engine is generally limited in a permissible size of the bypass fan, as increasing a size of the fan correspondingly increases a size and weight of the nacelle.

An open rotor engine, by contrast, operates on the principle of having the bypass fan located outside of the engine nacelle. This permits the use of larger rotor blades able to act upon a larger volume of air than for a traditional turbofan engine, potentially improving propulsive efficiency over conventional turbofan engine designs.

Engines with an open rotor design having a fan provided by two contra-rotating rotor assemblies have been studied. Each rotor assembly carries an array of airfoil blades located outside the engine nacelle. As used herein, “contra-rotational relationship” means that the blades of the first and second rotor assemblies are arranged to rotate in opposing directions to each other. Typically, the blades of the first and second rotor assemblies are arranged to rotate about a common axis in opposing directions, and are axially spaced apart along that axis. For example, the respective blades of the first rotor assembly and second rotor assembly may be co-axially mounted and spaced apart, with the blades of the first rotor assembly configured to rotate clockwise about the axis and the blades of the second rotor assembly configured to rotate counter-clockwise about the axis (or vice versa).

Contra-rotating rotor assemblies however present technical challenges in transmitting power from the power turbine to drive the blades of the rotor assemblies rotating in opposing directions.

### BRIEF DESCRIPTION

Aspects and advantages of the invention will be set forth in part in the following description, or may be obvious from the description, or may be learned through practice of the invention.

A propulsion system according to aspects of the present disclosure is provided, the propulsion system including a rotor assembly with a plurality of blades extended radially relative to the engine centerline axis, and a vane assembly positioned in aerodynamic relationship with the rotor assembly. The vane assembly includes a plurality of vanes extended radially relative to the engine centerline axis, and the propulsion system includes a ratio of a quantity of blades to a quantity of vanes between 2:5 and 2:1.

Another aspect of the present disclosure is directed to a propulsion system having an unducted single rotor assembly including a plurality of blades extended radially relative to the engine centerline axis. A vane assembly is positioned aft of the unducted rotor assembly and includes a plurality of vanes extended radially relative to the engine centerline axis. The propulsion system includes a ratio of a quantity of blades to a quantity of vanes between 2:5 and 2:1.

Another aspect of the present disclosure is directed to a propulsion system having an unducted single rotor assembly including a plurality of blades extended radially relative to the engine centerline axis. A vane assembly is positioned aft of the unducted rotor assembly and includes a plurality of vanes extended radially relative to the engine centerline axis. The propulsion system includes one or more of a ratio of a quantity of blades to a quantity of vanes between 2:5 and 2:1, a difference between the quantity of vanes and the quantity of blades is between 2 and −2, or a sum of blades and vanes between 20 and 30 These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a cross-sectional side view of an embodiment of a propulsion system according to an aspect of the present disclosure;

FIG. 2 is an exemplary embodiment of a vane of a vane assembly of the propulsion system of FIG. 1;

FIGS. 3-7 are roll-out views of embodiments of the vane assembly of the propulsion system of FIG. 1;

FIG. 8 is an exemplary embodiment of positions of an articulatable vane of the propulsion system of FIG. 1; and

FIG. 9 shows relative is a graph depicting noise levels versus quantities of blade and vanes for one or more embodiments of the engine depicted and described in regard to FIGS. 1-8.

Repeat use of reference characters in the present specification and drawings is intended to represent the same or analogous features or elements of the present invention.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

The word “exemplary” is used herein to mean “serving as an example, instance, or illustration.” Any implementation described herein as “exemplary” is not necessarily to be construed as preferred or advantageous over other implementations.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin in either individual values, range(s) of values and/or endpoints defining range(s) of values.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

References to “noise”, “noise level”, or “perceived noise”, or variations thereof, are understood to include sound pressure levels (SPL) outside a fuselage, fuselage exterior noise levels, perceived noise levels, effective perceived noise levels EPNL, instantaneous perceived noise levels PNL(k), or tone-corrected perceived noise levels PNLT(k), or one or more duration correction factors, tone correction factors, or other applicable factors, as defined by the Federal Aviation Administration (FAA), the European Union Aviation Safety Agency (EASA), the International Civil Aviation Organization (ICAO), Swiss Federal Office of Civil Aviation (FOCA), or committees thereof, or other equivalent regulatory or governing bodies. Where certain ranges of noise levels (e.g., in decibels, or dB) are provided herein, it will be appreciated that one skilled in the art will understand methods for measuring and ascertaining of such levels without ambiguity or undue experimentation. Methods for measuring and ascertaining one or more noise levels as provided herein by one skilled in the art, with reasonable certainty and without undue experimentation, include, but are not limited to, understanding of measurement systems, frames of reference (including, but not limited to, distances, positions, angles, etc.) between the engine and/or aircraft relative to the measurement system or other perceiving body, or atmospheric conditions (including, but not limited to, temperature, humidity, dew point, wind velocity and vector, and points of reference for measurement thereof), as may be defined by the FAA, EASA, ICAO, FOCA, or other regulatory or governing body.

It would be desirable to provide an open rotor propulsion system utilizing a single rotating rotor assembly analogous to a traditional turbofan engine bypass fan which reduces the complexity of the design, yet yields a level of propulsive efficiency comparable to contra-rotating propulsion designs with a significant weight and length reduction.

Embodiments of a single unducted rotor engine 10 are provided herein. Embodiments of the engine or propulsion system provided herein generate an increased unducted rotor efficiency at, and above a threshold power loading (i.e., power/area of rotor airfoil). In certain embodiments, the threshold power loading is 25 horsepower per ft² or greater at cruise altitude. In particular embodiments of the engine, structures and methods provided herein generate power loading between 25 horsepower/ft² and 100 horsepower/ft² at cruise altitude. Cruise altitude is generally an altitude at which an aircraft levels after climb and prior to descending to an approach flight phase. In various embodiments, the engine is applied to a vehicle with a cruise altitude up to approximately 65,000 ft. In certain embodiments, cruise altitude is between approximately 28,000 ft and approximately 45,000 ft. In still certain embodiments, cruise altitude is expressed in flight levels based on a standard air pressure at sea level, in which a cruise flight condition is between FL280 and FL650. In another embodiment, cruise flight condition is between FL280 and FL450. In still certain embodiments, cruise altitude is defined based at least on a barometric pressure, in which cruise altitude is between approximately 4.85 psia and approximately 0.82 psia based on a sea level pressure of approximately 14.70 psia and sea level temperature at approximately 59 degree Fahrenheit. In another embodiment, cruise altitude is between approximately 4.85 psia and approximately 2.14 psia. It should be appreciated that in certain embodiments, the ranges of cruise altitude defined by pressure may be adjusted based on a different reference sea level pressure and/or sea level temperature.

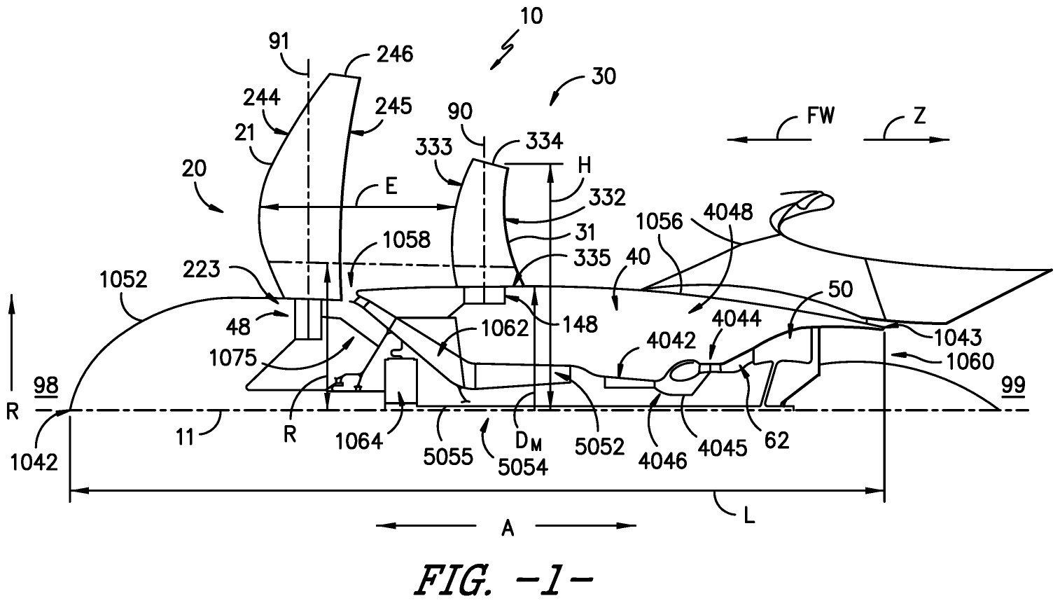

Various embodiments of the single unducted rotor engine include a vane assembly 30 in aerodynamic relationship with a bladed rotor assembly 20. Referring to FIG. 1, the vane assembly 30 is positioned aft (i.e., proximate to aft end 99) or generally downstream (relative to normal forward operation, schematically depicted by arrow FW) of a single unducted rotor assembly 20. The vane assembly 30 may generally define a de-swirler device configured to reduce or convert kinetic energy losses from unducted rotors into thrust output. In certain embodiments, the vane assembly 30 is configured to adjust vane pitch angle 90 based at least on output velocity vectors from the rotor assembly 20. The adjustable vane pitch angle is configured to output a desired thrust vector based on a desired engine operation (e.g., forward thrust, neutral or no thrust, or reverse thrust) and desired acoustic noise level. In still certain embodiments, the bladed rotor assembly 20 is configured to adjust blade pitch angle 91 based at least on a desired output velocity vector to the vane assembly 30, a desired engine operation, or a desired acoustic noise level. In still various embodiments, the rotor assembly 20 is configured to adjust rotor plane based on an angle of attack of incoming air to the rotor assembly, such as to adjust an output velocity vector to the vane assembly and reduce or eliminate undesired noise levels from the rotor assembly.

Certain embodiments of the single unducted rotor engine 10 provide noise reduction or attenuation based on dynamic blade pitch angle changes, vane pitch angle changes, and/or rotor plane angle changes relative to angle of attack of incoming air and output air velocity from the rotor assembly to an aft vane assembly. Additionally, or alternatively, embodiments of the engine 10 provided herein may attenuate low frequency noise, such as those that may propagate to the ground while an engine is at cruise altitude, or as may be referred to as “en-route noise.” Various embodiments of the engine are configured to desirably alter rotor plane angle, blade pitch angle, and/or vane pitch angle to mitigate propagation of undesired noise to the ground and the fuselage. Additionally, the engine 10 may be configured to desirably deflect noise upward (e.g., skyward) rather than toward the ground. As such, perceived noise levels may be reduced or mitigated by one or more structures provided herein.

Referring now to the drawings, FIG. 1 shows an elevational cross-sectional view of an exemplary embodiment of a single unducted rotor engine 10. As is seen from FIG. 1, the engine 10 takes the form of an open rotor propulsion system and has a rotor assembly 20 which includes an array of airfoil blades 21 around a longitudinal axis 11 of engine 10. Blades 21 are arranged in typically equally spaced relation around the longitudinal axis 11, and each blade 21 has a root 223 and a tip 246 and a span defined therebetween.

Additionally, engine 10 includes a gas turbine engine having a core (or high speed system) 40 and a low speed system. The core engine 40 generally includes a high speed compressor 4042, a high speed turbine 4044, and a high speed shaft 4045 extending therebetween and connecting the high speed compressor 4042 and high speed turbine 4044. The high speed compressor 4042, the high speed turbine 4044, and the high speed shaft 4045 may collectively define and be referred to as a high speed spool 4046 of the engine. Further, a combustion section 4048 is located between the high speed compressor 4042 and high speed turbine 4044. The combustion section 4048 may include one or more configurations for receiving a mixture of fuel and air and providing a flow of combustion gasses through the high speed turbine for driving the high speed spool 4046.

The low speed system 50 similarly includes a low speed turbine 5050, a low speed compressor or booster, 5052, and a low speed shaft 5055 extending between and connecting the low speed compressor 5052 and low speed turbine 5050. The low speed compressor 5052, the low speed turbine 5050, and the low speed shaft 5055 may collectively define and be referred to as a low speed spool 5054 of the engine.

It should be appreciated that the terms “low” and “high”, or their respective comparative degrees (e.g., -er, where applicable), when used with compressor, turbine, shaft, or spool components, each refer to relative speeds within an engine unless otherwise specified. For example, a “low turbine” or “low speed turbine” defines a component configured to operate at a rotational speed, such as a maximum allowable rotational speed, lower than a “high turbine” or “high speed turbine” at the engine. Alternatively, unless otherwise specified, the aforementioned terms may be understood in their superlative degree. For example, a “low turbine” or “low speed turbine” may refer to the lowest maximum rotational speed turbine within a turbine section, a “low compressor” or “low speed compressor” may refer to the lowest maximum rotational speed turbine within a compressor section, a “high turbine” or “high speed turbine” may refer to the highest maximum rotational speed turbine within the turbine section, and a “high compressor” or “high speed compressor” may refer to the highest maximum rotational speed compressor within the compressor section. Similarly, the low speed spool refers to a lower maximum rotational speed than the high speed spool. It should further be appreciated that the terms “low” or “high” in such aforementioned regards may additionally, or alternatively, be understood as relative to minimum allowable speeds, or minimum or maximum allowable speeds relative to normal, desired, steady state, etc. operation of the engine.

Although the engine 10 is depicted with the low speed compressor 5052 positioned forward (i.e., proximate to a forward end 98) of the high speed compressor 4042, in certain embodiments the compressors 4042, 5052 may be in interdigitated arrangement, i.e., rotary airfoils of the low speed compressor 5052 are in alternating arrangement along the gas flowpath with rotary airfoils of the high speed compressor 4042. Additionally, or alternatively, although the engine 10 is depicted with the high speed turbine 4044 positioned forward of the low speed turbine 5050, in certain embodiments the turbines 4044, 5050 may be in interdigitated arrangement. Although certain embodiments or descriptions of rotary elements provided herein may include “low pressure” or “high pressure”, it should be appreciated that the rotary elements may additionally, or alternatively, refer to “low speed” or “high speed”, respectively, such as based on interdigitated arrangements or otherwise provided above.

Referring to FIG. 1, the core engine 40 is generally encased in a cowl 1056 defining a maximum diameter D_{M}. The vane assembly 30 is extended from the cowl 1056 and positioned aft of the rotor assembly 20. In various embodiments, the maximum diameter is defined as a flowpath surface facing outward along the radial direction R in fluid communication with the flow of fluid egressed from the rotor assembly 20. In certain embodiments, the maximum diameter of the cowl 1056 corresponds substantially to a location or positioning of a root 335 of a vane 31 of the vane assembly 30 extended from the cowl 1056. The rotor assembly 20 further includes a hub 1052 extended forward of the plurality of blades 21.

In certain embodiments, the engine 10 defines a length L from a forward end 1042 of the hub 1052 to an aft end 1043 of the cowl 1056. However, it should be appreciated that the length L may correspond to an aft end of a rearward facing or pusher-configuration hub 1052 and rotor assembly 20. In still certain embodiments, the engine 10 defines the length L from an aft end 1043 of the cowl 1056, in which the aft end 1043 is positioned at an egress end or exhaust 1060 of the core engine 40. In various embodiments, the length L may exclude a dimension of an exhaust nozzle or cap positioned radially inward of a turbomachinery flowpath 1062. In various embodiments, the engine 10 includes a ratio of length (L) to maximum diameter (D_{M}) that provides for reduced installed drag. In one embodiment, L/D_{M} is at least 2. In another embodiment, L/D_{M} is at least 2.5. In various embodiments, it should be appreciated that the L/D_{M} is for a single unducted rotor engine.

The reduced installed drag may further provide for improved efficiency, such as improved specific fuel consumption. Additionally, or alternatively, the reduced drag may provide for cruise altitude engine and aircraft operation at or above Mach 0.5. In certain embodiments, the reduced drag provides for cruise altitude engine and aircraft operation at or above Mach 0.75. In certain embodiments, such as certain embodiments of L/D_{M}, the rotor assembly 20, and/or the vane assembly 30 positioned aft of the rotor assembly 20, the engine 10 defines a maximum cruise altitude operating speed between approximately Mach 0.55 and approximately Mach 0.85. In still particular embodiments, certain embodiments of L/D_{M}, the quantity of blades at the rotor assembly 20 to the quantity of vanes at the vane assembly 30, and/or the vane assembly 30 positioned aft of the rotor assembly 20 provides the engine 10 with a maximum cruise altitude operating speed between approximately Mach 0.75 and Mach 0.85.

Moreover, it will be appreciated that the engine 10 further includes a cowl 1056 surrounding the turbomachinery and defining at least in part an inlet 1058, an exhaust 1060, and the turbomachinery flowpath 1062 extending between the inlet 1058 and the exhaust 1060. The inlet 1058 is for the embodiment shown an annular or axisymmetric 360 degree inlet 1058 located between the rotor assembly 20 and the vane assembly 30, and provides a path for incoming atmospheric air to enter the turbomachinery flowpath 1062 (and compressors, combustion section, and turbines) radially inwardly of the vane assembly 30. Such a location may be advantageous for a variety of reasons, including management of icing performance as well as protecting the inlet 1058 from various objects and materials as may be encountered in operation.

As is depicted, the rotor assembly 20 is driven by the turbomachinery, and more specifically, is driven by the low speed spool 5054. More specifically, still, engine 10 in the embodiment shown in FIG. 1 includes a power gearbox 1064, and the rotor assembly 20 is driven by the low speed spool 5054 of the turbomachinery across the power gearbox 64. In such a manner, the rotating blades 21 of the rotor assembly 20 may rotate around the axis 11 and generate thrust to propel the engine 10, and hence an aircraft to which it is associated, in a forward direction FW.

The power gearbox 1064 may include a gearset for decreasing a rotational speed of the low speed spool 5054 relative to the low speed turbine 5050, such that the rotor assembly 20 may rotate at a slower rotational speed than the low speed spool 5054. In certain embodiments, the power gearbox 1064 includes a gear ratio of at least 4:1. Although in various embodiments the 4:1 gear ratio may generally provide for the low speed turbine 5050 to rotate at approximately four times the rotational speed of the rotor assembly 20, it should be appreciated that other structures provided herein, such as the blade pitch change mechanism and/or an electric machine, may allow the unducted rotor assembly 20 to operate substantially de-coupled from the low speed turbine 5050 rotational speed. Moreover, when using an interdigitated counter-rotating or vaneless turbine the gear ratio may be reduced without an appreciable loss in output power from the rotor assembly 20.

Single unducted rotor engine 10 also includes in the exemplary embodiment a vane assembly 30 which includes an array of vanes 31 also disposed around longitudinal axis 11, and each vane 31 has a root 335 and a tip 334 and a span defined therebetween. These vanes 31 are mounted to a stationary frame and do not rotate relative to the longitudinal axis 11. In certain embodiments, the vanes 31 include a mechanism for adjusting their orientation relative to their axis 90 and/or relative to the blades 21, such as further described herein. For reference purposes, FIG. 1 also depicts a forward direction denoted with arrow FW, which in turn defines the forward and aft portions of the system. As shown in FIG. 1, the rotor assembly 20 is located forward of the turbomachinery in a “puller” configuration, and the exhaust 1060 is located aft of the vane assembly 30.

It may be desirable that the blades 21, the vanes 31, or both, incorporate a pitch change mechanism such that the airfoils (e.g., blades 21, vanes 31, etc.) can be rotated with respect to an axis of pitch rotation either independently or in conjunction with one another. Such pitch change can be utilized to vary thrust and/or swirl effects under various operating conditions, including to provide adjust a magnitude or direction of thrust produced at the vanes 31, or to provide a thrust reversing feature which may be useful in certain operating conditions such as upon landing an aircraft, or to desirably adjust acoustic noise produced at least in part by the blades 21, the vanes 31, or aerodynamic interactions from the blades 21 relative to the vanes 31.

Vanes 31 are sized, shaped, and configured to impart a counteracting swirl to the fluid so that in a downstream direction aft of both rows of airfoils (e.g., blades 21, vanes 31) the fluid has a greatly reduced degree of swirl, which translates to an increased level of induced efficiency.

Vanes 31 may have a shorter span than blades 21, as shown in FIG. 1, for example, 50% of the span of blades 21, or may have longer span or the same span as blades 21 as desired. Vanes 31 may be attached to an aircraft structure associated with the propulsion system, as shown in FIG. 1, or another aircraft structure such as a wing, pylon, or fuselage. Vanes 31 of the stationary element may be fewer or greater in number than, or the same in number as, the number of blades 21 of the rotating element and typically greater than two, or greater than four, in number.

In certain embodiments, the plurality of blades 21 each have a loading distribution such that at any location between the blade root 223 and 30% blade span 246 the value of ΔRCu in the air stream is greater than or equal to 60% of the peak ΔRCu in the air stream. Cu is the circumferential averaged tangential velocity in a stationary frame of reference. Vector diagrams are shown in a coordinate system in which the axial direction is in the downward direction and tangential direction is left to right. Multiplying the Cu times the airstream radius R gives the property RCu. The blade or vane loading at a given radius R is now defined as the change in RCu across the blade row (at a constant radius or along a streamtube), here forth referred to as ΔRCu and is a measure of the elemental specific torque of said blade row. Desirably, the ΔRCu for the rotating element should be in the direction of rotation throughout the span.

In certain embodiments, the blade 21 defines a more uniform ΔRCu over the span, particularly in the region between the blade root 223 and midspan. In fact, at a location of 30% span the value of ΔRCu is greater than or equal to 60% of the maximum value of ΔRCu, and, in an embodiment, is greater than or equal to 70% of the maximum value of ΔRCu, and, in an embodiment, is greater than or equal to 80% of the maximum value of ΔRCu. ΔRCu is measured across the rotor assembly 20 in a conventional manner.

In certain embodiments, a change in the blade 21 cambers in the inner portion of the blade, i.e., from about 0 to approximately 50% span, and it is expected that characteristics of exemplary embodiments could also be loosely defined by a camber distribution. At least one of the following criteria are met: at 30% span the blade camber is at least 90% of the max camber level between 50% and 100% span; and the 0% span camber is at least 110% of the max camber between 50% and 100% span. Embodiments of the blade 21 may include geometries or features providing loading distribution such as provided in U.S. patent Ser. No. 10/202,865 B2 “Unducted Thrust Producing System” in Appendix A, and herein incorporated by reference in its entirety for all purposes.

Blades 21 may include a metal leading edge (MLE) wrap for withstanding foreign object debris (FOD), such as bird strikes, during engine operation. In particular embodiments, the blades 21 include a sheet metal sheath at the leading edge. In various embodiments, the blades 21 include one or more features, including orifices, voids, openings, cavities, or other frangible features configured to desirably liberate portions of the blade 21, such as to minimize damage to the fuselage of an aircraft.

In various embodiments, the plurality of vanes 31 and/or aircraft surfaces 1160 may include leading edge treatments such as to reduce acoustic interactions between the rotor assembly 20 and the vanes or aircraft surfaces positioned downstream of the rotor assembly 20. The vanes 31 and/or aircraft surface 1160 may include a surface modification element defining a modified contour configured to decorrelate a phase distribution of a plurality of sound sources within a source field positioned on at least a portion of the vane or aircraft surface. Embodiments of the vane 31 and/or aircraft surface 1160 may include geometries of features such as one or more surface modification elements such as provided in US Patent Application No. US 2017/0225773 A1 “Wing Leading Edge Features to Attenuate Propeller Wake-Wing Acoustic Interactions”, and herein incorporated by reference in its entirety for all purposes.

In certain embodiments, the engine 10 includes one or more of a desired ratio of blades 21 to vanes 31, a difference in a quantity of blades 21 to a quantity of vanes 31, or sum of the quantity of blades 21 and the quantity of vanes 31, providing particular and unexpected benefits such as further described herein. Furthermore, it should be appreciated that it may be desirable to produce thrust from the rotor assembly 20 depicted and described herein within one or more particular ranges of quantity of blades 21, or more particularly, ranges of ratios, differences, and/or sums of blades 21 to vanes 31, such as to reduce interaction noise between an unducted rotor assembly and a vane assembly. Still further, it should be appreciated that although certain embodiments of turbo machines may provide partially overlapped ranges of quantities of thrust-producing blades, the present disclosure provides ranges, differences, or sums that, at least in part, provide a desired thrust for an unducted rotor assembly while attenuating or mitigating noise produced by an interaction of the blades 21 and the vanes 31, or attenuating noise perceived by an observer or measurement device. Additionally, or alternatively, one or more vanes 31 or vane structures depicted and described herein may include or be configured at, at least in part, one or more aircraft surfaces 1160 such as described herein, including, but not limited to, a wing, pylon, fuselage, empennage, or non-wing surface.

In various embodiments, the engine 10 includes a ratio of a quantity of blades 21 to a quantity of vanes 31 between 2:5 and 2:1, or between 2:4 and 3:2, or between 0.5 and 1.5. In certain embodiments, a difference between the quantity of blades 21 and the quantity of vanes 31 is between two (2) and negative two (−2), or between one (1) and negative one (−1). In various embodiments, the quantity of blades 21 is twenty (20) or fewer. In still certain embodiments, a sum of the quantity of blades 21 and the quantity of vanes 31 is between twenty (20) and thirty (30), or between twenty-four (24) and twenty-eight (28), or between twenty-five (25) and twenty-seven (27). In one embodiment, the engine 10 includes a quantity of blades 21 between eleven (11) and sixteen (16). In another embodiment, the engine 10 includes twelve (12) blades 21 and ten (10) vanes 31. In still another embodiment, the engine 10 includes between three (3) and twenty (20) blades 21 and between three (3) and twenty (20) vanes 31. In yet another embodiment, the engine 10 includes an equal quantity of blades 21 and vanes 31. In still yet another embodiment, the engine 10 includes an equal quantity of blades 21 and vanes 31, in which the quantity of blades 21 is equal to or fewer than twenty (20). In various embodiments, the engine 10 includes a combination of the quantity of blades 21 to the quantity of vanes 31 between 2:5 and 2:1, the difference between the quantity of blades 21 and the quantity of vanes 31 between two (2) and negative two (−2), and the quantity of blades 21 between eleven (11) and sixteen (16). For example, a difference between the quantity of blades and the quantity of vanes may correspond to an engine having fourteen (14) blades and sixteen (16) vanes, or fourteen (14) blades and twelve (12) vanes, or sixteen (16) blades and eighteen (18) vanes, or sixteen (16) blades and fourteen (14) vanes, or eleven (11) blades and thirteen (13) vanes, or eleven (11) blades and nine (9) vanes, etc.

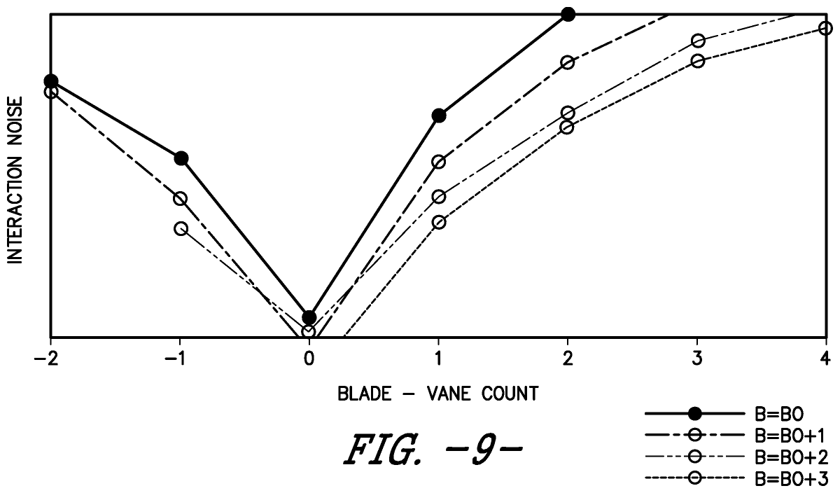

Referring now to FIG. 9, provides a chart depicting interaction noise levels versus differences of quantities of blades 21 to quantities of vanes 31 such as described herein. FIG. 9 depicts particular ranges of quantities of blades 21 to quantities of vanes 31 such as described herein to provide unexpected results such as described herein. It should further be appreciated that differences provided herein and in regard to FIG. 9 result from an evaluation of noise levels. It should be appreciated that desirable ranges of ratios, differences, sums, or discrete quantities of blades 21 and vanes 31 provided herein, or combinations thereof, provide noise levels such as depicted and described in regard to FIG. 9. The noise levels depicted and described in regard to FIG. 9 are obtained at the fundamental blade passing frequency of the blade assembly 20 (referred to herein as “1BPF frequency”) at an operating condition representative of certification point for noise. The 1BPF frequency is a dominant contributor to the overall noise signature of the blade assembly 20 at this operating condition. For a given quantity of blades 21 (B0), a minimum level of noise occurs when the number of blades and vanes are equal, with the noise level increasing as the absolute value of the difference in the quantity of blades 21 and the quantity of vanes 31 increases. The quantity of blades 21 may be changed (e.g., depicted via lines B0+1, B0+2, B0+3), the lowest noise levels are still obtained for differences of the quantity of blades 21 to the quantity of vanes 31 between +2 and −2.

In particular embodiments, a combination of the vane assembly 30 positioned aerodynamically aft of the blade assembly 20 to recover swirl in the flow such as described herein and the differences between the quantities of blades 21 and vanes 31 allow for decreased noise such as depicted in FIG. 9. The vane assembly 20 being stationary relative to the engine centerline axis allows for reduced radiation efficiency of noise and redirects the noise in a manner favorable to use the difference between the quantities of blades 21 and vanes 31 such as described herein. In contrast, engines including counter-rotating unducted fan or propeller rotors with approximately equal blade counts for the forward and aft blade rows may generally result in increased noise radiation compared to a counter-rotating unducted fan or propeller rotor engine including a greater difference in blade counts between the forward and aft blade rows.

It should be appreciated that embodiments of the engine 10 including one or more ranges of ratios, differences, or sums of blades 21 to vanes 31 depicted and described herein may provide advantageous improvements over turbofan or turboprop gas turbine engine configurations. In one instance, embodiments of the engine 10 provided herein allow for thrust ranges similar to or greater than turbofan engines with larger quantities of blades or vanes, while further obviating structures such as fan cases or nacelles. In another instance, embodiments of the engine 10 provided herein allow for thrust ranges similar to or greater than turboprop engines with similar quantities of blades, while further providing reduced noise or acoustic levels such as provided herein. In still another instance, embodiments of the engine 10 provided herein allow for thrust ranges and attenuated acoustic levels such as provided herein while reducing weight, complexity, or issues associated with fan cases, nacelles, variable nozzles, or thrust-reverser assemblies at the nacelle.

It should further be appreciated that ranges of ratios, differences, sums, and/or discrete quantities of blades 21 to vanes 31 provided herein may provide particular improvements to gas turbine engines in regard to thrust output and acoustic levels. For instance, quantities of blades greater than those of one or more ranges provided herein may produce noise levels that may disable use of an open rotor engine in certain applications (e.g., commercial aircraft, regulated noise environments, etc.). In another instance, quantities of blades less than those ranges provided herein may produce insufficient thrust output, such as to render an open rotor engine non-operable in certain aircraft applications. In yet another instance, quantities of vanes less than those of one or more ranges provided herein may fail to sufficiently produce thrust and abate noise, such as to disable use of an open rotor engine in certain applications. In still another instance, quantities of vanes greater than those of ranges provided herein may result in increased weight that adversely affects thrust output and noise abatement.

It should be appreciated that various embodiments of the single unducted rotor engine 10 depicted and described herein may allow for normal subsonic aircraft cruise altitude operation at or above Mach 0.5. In certain embodiments, the engine 10 allows for normal aircraft operation between Mach 0.55 and Mach 0.85 at cruise altitude. In still particular embodiments, the engine 10 allows for normal aircraft operation between Mach 0.75 and Mach 0.85. In certain embodiments, the engine 10 allows for rotor blade tip speeds at or less than 750 feet per second (fps).

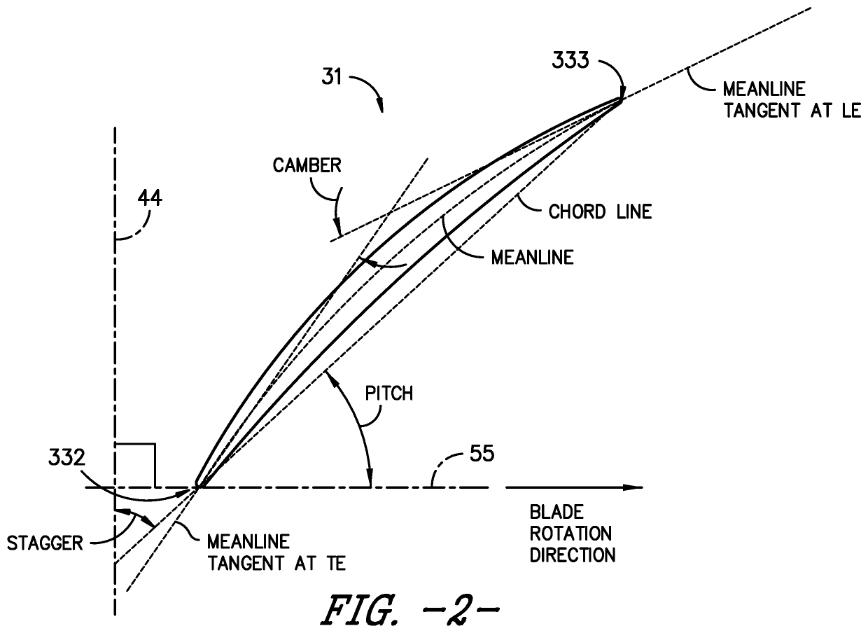

Referring back to FIG. 1, and further in conjunction with FIGS. 2-9, in certain embodiments, the vane assembly 30 includes a plurality of vane airfoils 31 arranged in a spaced apart manner. Referring briefly to FIG. 2, an exemplary airfoil 31 is provided graphically depicting how various parameters such as camber and stagger angle are defined with respect to the airfoil, such as the vane 31 (FIG. 1). An airfoil meanline is described as a line that bisects the airfoil thickness (or is equidistant from the suction surface and pressure surface) at all locations. The meanline intersects the airfoil at a leading edge (LE) and a trailing edge (TE). The camber of an airfoil is defined as the angle change between the tangent to the airfoil meanline at the leading edge and the tangent to the angle meanline at the trailing edge. The stagger angle is defined as the angle the chord line makes with the centerline axis (e.g., reference line 44). Reference line 44 is parallel to axis 11, and reference line 55 is orthogonal to reference line 44.

In certain embodiments, one or more of the plurality of vanes 31 is rotatable about a vane pitch axis (e.g., vane pitch axis 90 in FIG. 1). In other embodiments, one or more of the plurality of vanes 31 is fixed about the vane pitch axis 90. It should be appreciated that in still certain embodiments, one or more, or all, of the plurality of vanes 31 is fixed in certain arrangements such as described herein. A vane characteristics actuation assembly may be utilized to provide to one or more of the vanes 31 collective, independent, or ganged (i.e., a first set of vanes differently and/or independently operable from a second set of vanes, such as depicted and described herein) adjustment of the orientation or airfoil characteristics of the vane 31 about the vane pitch axis of each respective vane 31. Such independent or collective adjustment of pitch angle of the vane 31 about the vane pitch axis may be utilized for attenuating undesired acoustic noise, for producing a desired thrust vector, and/or for producing a desired thrust load.

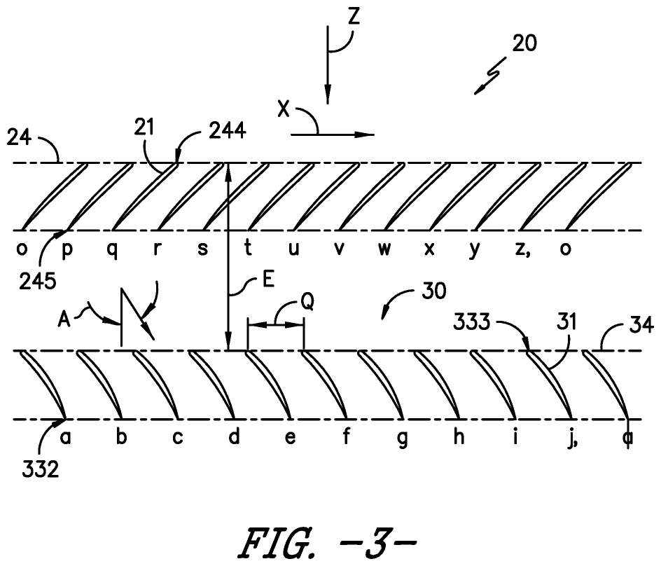

FIGS. 3-7 each include illustrations of radial sections of the engine 10 taken through stages of axial flow airfoils and nearby aircraft surfaces, typically referred to as “roll-out-views”, such as a projection of blades about circumference onto a plane. These views are generated by sectioning airfoil stages and aircraft surfaces at a fixed radial dimension measured radially from longitudinal axis 11 and reference dimension R in FIG. 1. When blades 21 and vanes 31 of respective rotor assembly 20 and vane assembly 30 are sectioned at reference dimension R, corresponding blade 21 and vanes 31 are generated. Then the blades 21 and vanes 31 are unrolled or ‘rolled-out’ to view the sections in two-dimensional space while maintaining the circumferential and axial relationships between the airfoil stages and any nearby aircraft surfaces. Reference dimension E for the axial spacing between blades 21 and vanes 31. This allows the rotor assembly 20 and the vane assembly 30 in FIGS. 3-7 to be described in two dimensions. An axial dimension, parallel to the longitudinal axis 11 and generally aligned with the direction Z of the moving working fluid shown in FIG. 1, and a ‘rolled-out’ or flattened circumferential dimension X, orthogonal to the axial dimension.

FIG. 3 illustrates a cross-sectional “roll-out view” of rotor assembly 20 which as depicted includes twelve blades 21. Each blade 21 is individually labeled with lower case letters o through z, with the blade 21 labeled o repeating at the end of the sequence to highlight the actual circumferential nature of rotor assembly 20. Each blade 21 has a blade leading edge 244. A line positioned in the circumferential direction X through each blade leading edge 244 defines a rotor plane 24. Each blade 21 is spaced apart from one another and is located axially at the rotor plane 24.

Similar to the rotor assembly 20, the vane assembly 30 depicted in FIG. 3 has ten vanes 31, individually labeled a through j, each with a vane leading edge 333. A line positioned in the circumferential direction through each vane leading edge 333 defines a stator plane 34. In FIG. 3, each vane 31 in the vane assembly 30 is identical in size, shape, and configuration, and is evenly spaced circumferentially from each other (i.e., along reference dimension P) and evenly spaced axially from the rotor plane 24 (i.e., in regard to reference dimension E). A nominal, evenly distributed circumferential spacing Q, between vanes 31 can be defined by the following equation using the radial height of the reference dimension R, and the number of vanes 31, N, in vane assembly 30:

Q=R*2*π/N

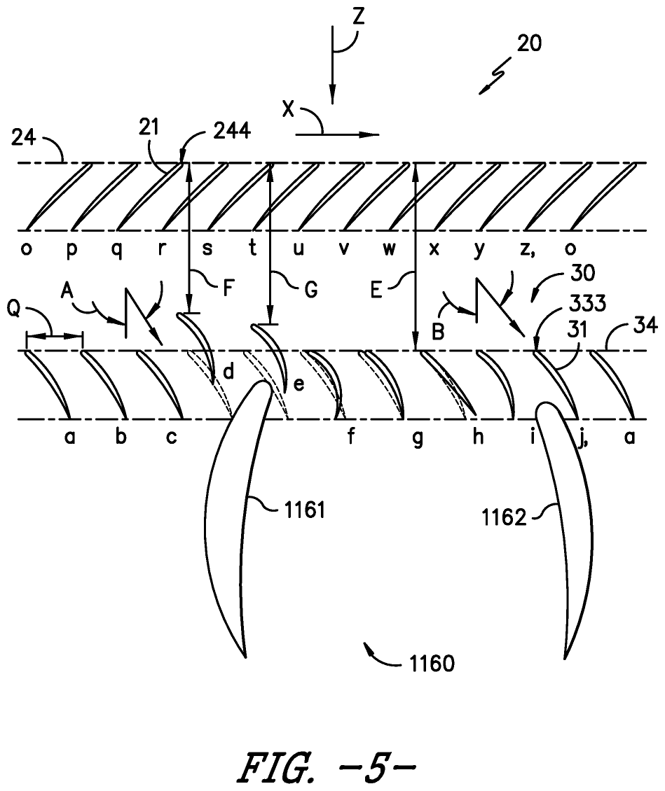

As will be further depicted and described herein, the engine 10 may include a controller configured to adjust the position of one or more vanes 31, the blade pitch angle of the plurality of blades 21 at the rotor assembly 20 (e.g., in regard to FIGS. 2-7), and/or the rotor plane 24 of the rotor assembly 20 relative to the plurality of blades 21 of the rotor assembly 20. In certain embodiments, the pitch angle at pitch axis (e.g., vane pitch axis 90 in FIG. 1), the longitudinal or axial spacing of a respective vane leading edge 333 to the rotor plane 24, and/or the circumferential spacing of two or more vanes 31 along reference dimension Q is adjusted to improve the acoustic signature of the engine 10 relative to various operational conditions of the engine 10 and/or the aircraft (e.g., angle of attack). Exemplary embodiments of adjustments or positioning of the vane assembly 30 relative to the rotor assembly 20 are further provided in regard to FIGS. 5-7. In each of these figures, the rotor assembly 20 and vane assembly 30 are located axially forward of a wing of an aircraft. Additionally, an exemplary embodiment of an aircraft surface 1160 is represented as two wing sections 1161, 1162. Note that two wing sections are present in each “roll-out view,” because the radial section that generates these installed views cuts through the wing of an aircraft in two circumferential locations. For the non-uniform vanes 31 in all of the Figures which follow, this dashed and solid line depiction method is used to refer to exemplary embodiments of nominal and non-nominal vanes 31 respectively.

To minimize the acoustic signature, it is desirable to have the aerodynamic loading of the vane leading edges 333 to all be similar and be generally not highly loaded. To maximize the efficiency and minimize the acoustic signature of the rotor assembly 20, a desired goal would be to minimize the variation in static pressure circumferentially along the rotor assembly 20. Additionally, or alternatively, a desired goal would be to minimize the acoustic signature to make an unsteady loading on the plurality of vanes 31 as similar as possible. To maximize the performance of the vane assembly 30, another goal would be to have neither the aerodynamic loadings of the vane leading edges 333 nor the vane suction and pressure surface diffusion rates lead to separation of the flow.

To maximize the performance of the aircraft surface, depicted in these exemplary embodiments as a wing sections 1161 and 1162, one goal may be to keep the wing loading distribution as similar to the loading distribution the wing was designed for in isolation from the engine 10, thus maintaining its desired design characteristics. The goal of maintaining the aircraft surface 1160 performance as designed for in isolation from the engine 10 applies for aircraft surfaces that may be non-wing, including, for example, fuselages, pylons, and the like. Furthermore, to maximize the performance of the overall aircraft and engine 10, one of the goals would be to leave the lowest levels of resultant swirl in the downstream wake. As described herein, the non-uniform characteristics of the vanes 31 is adjusted based on one or more of these desired goals during operation of the engine 10 and aircraft.

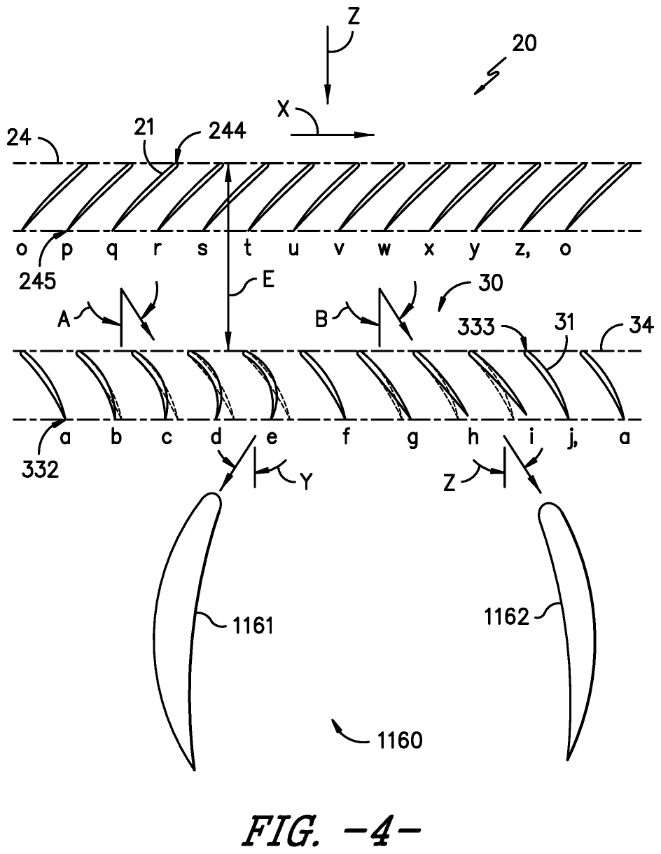

This optimal performance can be accomplished in part by developing non-uniform vane exit flow angles, shown in FIG. 4 as angles Y and Z, to minimize interaction penalties of the engine installation and to reduce the acoustic signature. The first exemplary embodiment of this is shown in FIG. 4, where each pair of vanes 31 in the vane assembly 30 are evenly spaced circumferentially from one another and evenly spaced axially from the rotor plane 24. However, the nominal (without pitch change) stagger angle and camber of the vanes 31 in FIG. 4 vary to provide optimal exit flow angles into the aircraft surface downstream of the vane assembly 30, such as depicted in regard to reference vanes 31 labeled b through e, and g through i.

FIG. 5 shows another exemplary embodiment of vane assembly 30 providing flow complimentary to aircraft surface 1160. In FIG. 5, vanes 31 and related vanes 31 in vane assembly 30 are not evenly spaced circumferentially from each other, nor are they evenly spaced axially from the rotor plane 24. The degree of non-uniformity may vary along the span of a vane. Two vanes 31 are spaced axially forward of the stator plane 34, reference dimensions F and G, allowing the vane assembly 30 to merge axially with the aircraft surface 1160. For instance, the aircraft surface 1160 may at least partially include or define at least one of the vanes 31 of the vane assembly 30. The nominal (without pitch change) stagger angle and camber angle of the vanes 31 vary to provide optimal exit flow angles into the wing sections 1161 and 1162, as shown in vanes 31 labeled d through i.

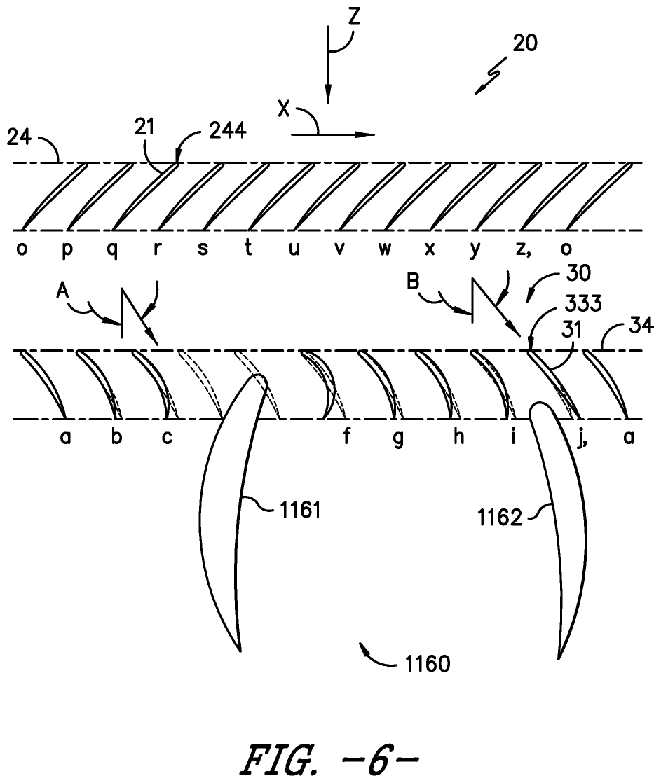

FIG. 6 is similar to FIG. 5. However, FIG. 5 depicts the removal of two vanes 31 adjacent to wing section 1161. This exemplary embodiment allows the vanes 31 to be evenly spaced axially from the rotor plane 24 and allows the wing section to merge axially with the vane assembly 30.

Although the location of the rotor assembly 20 and vane assembly 30 in each of the foregoing exemplary embodiments was axially forward of the aircraft surface 1160, it is foreseen that the engine 10 could be located aft of the aircraft surface 1160. In these instances, the prior enumerated goals for optimal installed performance are unchanged. It is desirable that the propulsion system has suitable rotor assembly 20 circumferential pressure variations, vane leading edge 333 aerodynamic loadings, and vane pressure surface and suction surface diffusion rates. This is accomplished in part by varying the size, shape, and configuration of each vane 31 and related vane 31 in the vane assembly 30 alone or in combination with changing the vane 31 pitch angles. For these embodiments, additional emphasis may be placed on assuring the combined engine 10 and aircraft leave the lowest levels of resultant swirl in the downstream wake.

Certain embodiments of the vane assembly 30 depicted and described in regard to FIGS. 5-6 may increase interaction noise generated by the rotor wakes impinging on the vane assembly 30 due to the non-uniform positioning of the vane leading edges 333. However embodiments of arrangements of the vane assembly 30 may advantageously and unexpectedly minimize overall noise from the rotor assembly 20 and the vane assembly 30 based at least on relative magnitudes of interaction noise from the vane assembly 30 and noise generated due to a high level of non-uniform back pressure on the rotor assembly 20 while maximizing overall performance of the engine 10 as installed to a vehicle, such as described herein regarding one or more of the cruise speed, blade tip speed, power loading, and L/D_{M}.

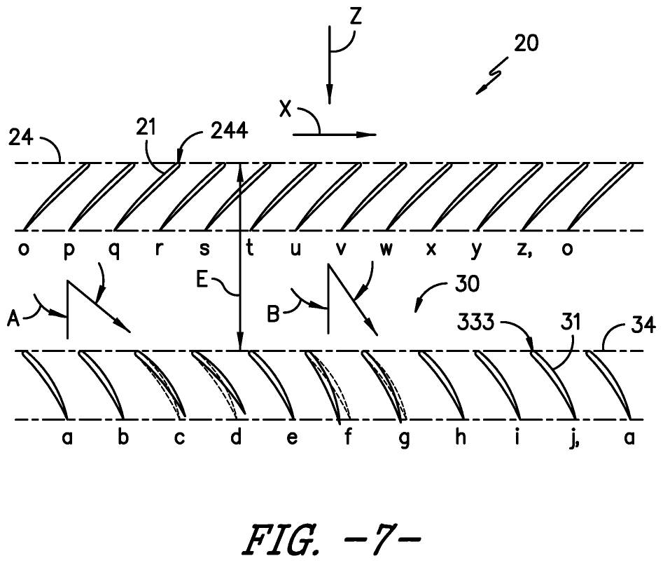

The exemplary embodiment of the rotor assembly 20 and vane assembly 30 in FIG. 3 is designed for a receiving a constant swirl angle, reference angle A, into vanes 31 along the stator plane 34. However, as the aircraft angle of attack is varied the vanes move to off design conditions and the swirl angle into the vane assembly 30 will vary around the stator plane 34. Therefore, to keep the aerodynamic loading on the vane leading edges 333 roughly consistent along the stator plane 34, a variable pitch system that would rotate either each vane 31 or group of vanes 31 a different amount is desirable. Such a pitch change can be accomplished by rotating a vane 31 in a solid body rotation along any axis, including, for example, the axis along the centroid of vane 31 or an axis along the vane leading edge 333. The desire for similar aerodynamic loading on the vane leading edges 333 is in part driven by the desire to keep the acoustic signature of the engine 10 low. Vanes 31 with high leading edge loadings tend to be more effective acoustic radiators of the noise created from the gust of the upstream rotor assembly 20. The exemplary embodiment of the rotor assembly 20 and vane assembly 30 in FIG. 7 describes this desired variation in vane 31 via changes in pitch angles of one or more vanes 31. For ease of explanation, we define the chord line angle of vanes at the design point as stagger and hence variations between vanes at the design point as stagger variations. As the engine 10 moves to different operating conditions, or as the aircraft to which the engine is attached moves to different operating conditions (e.g., takeoff, climb, cruise, approach, landing, etc.), vanes 31 may rotate around the pitch axis 90 referred to as pitch change (or changes in pitch angle) of the vanes 31. Variations in vane chord angles that result from these solid body rotations are referred to as pitch angle variations.

In FIG. 7, each vane 31 in the vane assembly 30 is identical in size, shape, and configuration, and are evenly spaced circumferentially from each other and evenly spaced axially from the rotor plane 24. However, the pitch angles of the vanes 31 in FIG. 7 vary as they represent a change in the vane 31 pitch actuation to accommodate varying input swirl, reference different input swirl angles A and B, into stator plane 34 caused in part by changes in aircraft angle of attack. As desired, this provides similar aerodynamic loading on the vane leading edges 333 to keep the acoustic signature of the engine 10 low, such as within one or more ranges further described herein. This similar loading can be accomplished by independently changing pitch angle for individual vanes 31 via a vane characteristics change mechanism, or by changing pitch angles similarly for groups of vanes 31 suitable for ganging. The vanes 31 could rotate in pitch about any point in space, but it may be desirable to maintain the original leading edge 333 circumferential spacing and rotate the vanes 31 around a point at or near their leading edge 333. This is shown in FIG. 7 using vanes 31 labeled c, d, f, and g, where the nominal staggered vanes 31 are depicted in dashed lines and the rotated (or pitched) vanes 31 are depicted as solid lines.

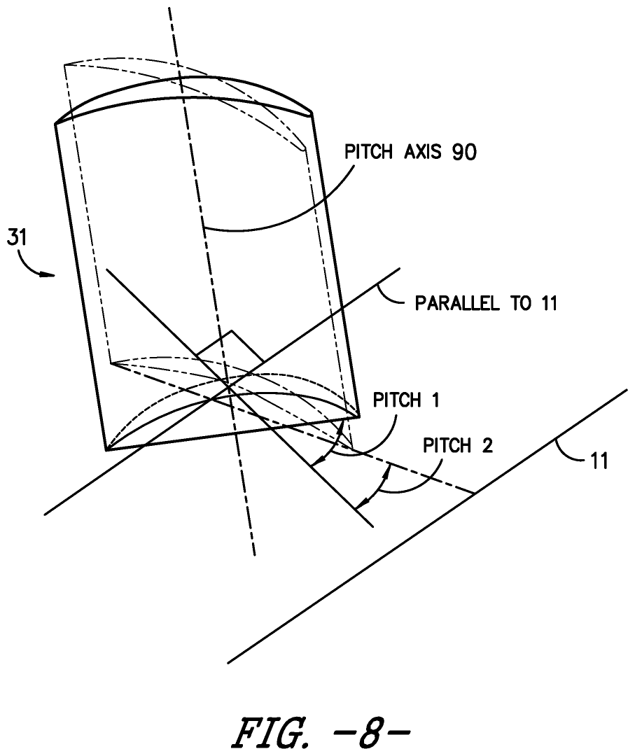

As shown by way of example in FIG. 8, it may be desirable that either or both of the sets of blades 21 and vanes 31 incorporate a pitch or airfoil characteristics change mechanism such that the blades and vanes can be rotated with respect to an axis of pitch rotation either independently or in conjunction with one another. Such pitch change can be utilized to vary thrust and/or swirl effects under various operating conditions, including providing thrust reversing, acoustic noise attenuation, or desired thrust vector, which may be useful in certain operating conditions of the engine 10 and/or aircraft.

The vane assembly 30, as suitable for a given variation of input swirl and aircraft surface 1160 installation, has non-uniform characteristics or parameters of vanes with respect to one another selected either singly or in combination from those which follow. A delta in stagger angle between neighboring vanes 31 according to one embodiment of greater than or equal to about 2 degrees can be employed, and according to another embodiment between about 3 degrees and about 20 degrees. A delta in camber angle between neighboring vanes 31 and related vanes 31 according to one embodiment of greater than or equal to about 2 degrees can be employed, and according to another embodiment between about 3 degrees and about 15 degrees. A circumferential spacing Q at a given reference dimension R, between neighboring vanes 31 and related vanes 31, for vane 31 counts N from about 5 to about 20, from about 10% to about 400% of the nominal, even circumferential spacing can be employed. An axial spacing from the rotor plane 24 to vanes 31 and related vanes 31 up to about 400% of the radial height H, of the vane 31 can also be employed.

The non-uniform characteristic may be attributed to a portion of the span of the vanes, or to substantially all of the span of the vanes. In certain embodiments, at least a portion, or all, of the plurality of vanes 31 of the vane assembly 30 may include a vane characteristics actuation mechanism in which the vane characteristics actuation mechanism is configured to adjust at least a pitch axis and/or axial spacing such as described herein.

Still various embodiments of the vane assembly 30 provided herein may include at least one vane defining a pylon or aircraft surface (e.g., aircraft surface 1160). It should be appreciated that vane pitch angle changes may desirably alter thrust direction to or away from the pylon surface, such as described herein, to attenuate generation of undesired noise. In certain embodiments, one or more aircraft surfaces, such as the pylon, may include pitch change mechanisms, flaps, or actuators configured to perform substantially similarly as one or more vanes depicted and described herein.

Various embodiments of the engine 10 depicted and described herein provide novel improvements over known propulsion systems. Embodiments of the engine 10 include, but are not limited to, one or more ranges of ratios of blades to vanes, length to maximum diameter, vane spacing or orientation (i.e., vane pitch angle) relative to one or more blades or blade pitch angle, or combinations thereof. It should be appreciated that, to the extent one or more structures or ranges may overlap one or more of those known in the art, certain structures with certain turbo machine arrangements may be generally undesired to combine with other structures of other turbo machine arrangements. For instance, turbofan configurations generally include certain quantities of vanes to provide structural support for a casing surrounding a rotor assembly, without providing any teaching or motivation in regard to thrust output and noise abatement particular to open rotor engines. In another instance, turboprop or turboshaft configurations generally exclude vane assemblies since the added structure may increase weight without providing other benefits for turboprop or turbofan applications.

In still another instance, certain ranges of blades to vanes described herein provide unexpected benefits not previously known in the art, or furthermore, not previously known in the art for single stage unducted rotor assemblies. In still yet another instance, certain ranges of blades to vanes with certain ranges of length to maximum diameter of the engine provide unexpected benefits not previously known in the art, or furthermore, not previously known in the art for single stage unducted rotor assemblies. In still particular embodiments, certain ranges, differences, or sums of blades and vanes provided herein provide unexpected benefits not previously known in the art, such as reduced interaction noise between the blade assembly 20 and the vane assembly 30.

Still further, certain embodiments of the engine 10 provided herein may allow for normal subsonic aircraft cruise altitude operation at or above Mach 0.5, or above Mach 0.75, based at least on ranges or quantities of blades to vanes and/or ranges of blades to vanes and length to maximum diameter, and/or in combination with other structures provided herein. In certain embodiments, the engine 10 allows for normal aircraft operation between Mach 0.55 and Mach 0.85, or between Mach 0.75 to Mach 0.85 at cruise altitude. In certain embodiments, the engine 10 allows for rotor blade tip speeds at or less than 750 feet per second (fps). In still certain embodiments, the core engine 40 and rotor assembly 20 are together configured to produce a threshold power loading is 25 horsepower per ft² or greater at cruise altitude. In particular embodiments of the engine 10, structures and ranges provided herein generate power loading between 25 horsepower/ft² and 100 horsepower/ft² at cruise altitude. Still particular embodiments may provide such benefits with reduced interaction noise between the blade assembly 20 and the vane assembly 30 and/or decreased overall noise generated by the blade assembly 20 and the vane assembly 30. Additionally, it should be appreciated that ranges of power loading and/or rotor blade tip speed may correspond to certain structures, core sizes, thrust outputs, etc., or other structures at the core engine 40 and the rotor assembly 20. However, as previously stated, to the extent one or more structures provided herein may be known in the art, it should be appreciated that the present disclosure may include combinations of structures not previously known to combine, at least for reasons based in part on conflicting benefits versus losses, desired modes of operation, or other forms of teaching away in the art.

It should furthermore be appreciated that certain unexpected benefits of various embodiments of the engine 10 provided herein may provide particular improvements to propulsion systems in regard to thrust output and acoustic levels. For instance, quantities of blades greater than those of one or more ranges provided herein may produce noise levels that may disable use of an open rotor engine in certain applications (e.g., commercial aircraft, regulated noise environments, etc.). In another instance, quantities of blades less than those ranges provided herein may produce insufficient thrust output, such as to render an open rotor engine non-operable in certain aircraft applications. In yet another instance, quantities of vanes less than those of one or more ranges provided herein may fail to sufficiently produce thrust and abate noise, such as to disable use of an open rotor engine in certain applications. In still another instance, quantities of vanes greater than those of ranges provided herein may result in increased weight that adversely affects thrust output and noise abatement.

It should be appreciated that embodiments of the engine 10 including one or more ranges of ratios, differences, sums, or discrete quantities of blades 21 to vanes 31 depicted and described herein may provide advantageous improvements over turbofan or turboprop gas turbine engine configurations. In one instance, embodiments of the engine 10 provided herein allow for thrust ranges similar to or greater than turbofan engines with larger quantities of blades or vanes, while further obviating structures such as fan cases or nacelles. In another instance, embodiments of the engine 10 provided herein allow for thrust ranges similar to or greater than turboprop engines with similar quantities of blades, while further providing reduced noise or acoustic levels such as provided herein. In still another instance, embodiments of the engine 10 provided herein allow for thrust ranges and attenuated acoustic levels such as provided herein while reducing weight, complexity, or issues associated with fan cases, nacelles, variable nozzles, or thrust-reverser assemblies at a turbofan nacelle.

This written description uses examples to disclose the invention, including the best mode, and also to enable any person skilled in the art to practice the invention, including making and using any devices or systems and performing any incorporated methods. The scope of the invention(s) described herein is defined by one or more of the claims, including combinations of two or more claims or clauses (as set forth below) and may include other examples that occur to those skilled in the art. For example, aspects of the invention(s) are provided by the subject matter of the following clauses, which are intended to cover all suitable combinations unless dictated otherwise based on logic or the context of the clauses and/or associated figures and description:

1. A propulsion system defining an engine centerline, the propulsion system comprising a rotor assembly comprising a plurality of blades extended radially relative to the engine centerline axis, and a vane assembly positioned aft of the rotor assembly, the vane assembly comprising a plurality of vanes extended radially relative to the engine centerline axis, wherein the propulsion system comprises a ratio of a quantity of blades to a quantity of vanes between 2:5 and 2:1.

2. The propulsion system in accordance with one or more clauses herein, wherein the quantity of blades is twenty or fewer.

3. The propulsion system in accordance with one or more clauses herein, wherein the quantity of blades is between three and twenty.

4. The propulsion system in accordance with one or more clauses herein, wherein the quantity of vanes is thirty or fewer.

5. The propulsion system in accordance with one or more clauses herein, wherein the quantity of vanes is between five and thirty.

6. The propulsion system in accordance with one or more clauses herein, wherein the quantity of blades is twelve, and wherein the quantity of vanes is ten.

7. The propulsion system in accordance with one or more clauses herein, wherein the quantity of blades is equal to the quantity of vanes.

8. The propulsion system in accordance with one or more clauses herein, wherein the rotor assembly is unducted.

9. The propulsion system in accordance with one or more clauses herein, wherein the vane assembly is unducted.

10. The propulsion system in accordance with one or more clauses herein, wherein the rotor assembly comprises a blade pitch change mechanism configured to control blade pitch at one or more of the plurality of blades.

11. The propulsion system in accordance with one or more clauses herein, wherein the vane assembly comprises a vane pitch change mechanism configured to control vane pitch at one or more of the plurality of vanes.

12. A system for reducing noise generation for a single unducted rotor engine, the system comprising the propulsion system in accordance with one or more clauses herein.

13. A propulsion system defining an engine centerline, the propulsion system comprising an unducted rotor assembly comprising a plurality of blades extended radially relative to the engine centerline axis, the rotor assembly configured to generate thrust substantially co-directional to the engine centerline axis, and a vane assembly positioned aft of the rotor assembly, the vane assembly comprising a plurality of vanes extended radially relative to the engine centerline axis, wherein the propulsion system generates a power loading at the rotor assembly of at least 25 horsepower per ft² at cruise altitude.

14. The propulsion system in accordance with one or more clauses herein, wherein the propulsion system generates a power loading at the rotor assembly of 100 horsepower per ft² or less at cruise altitude.

15. The propulsion system in accordance with one or more clauses herein, wherein cruise altitude comprises an ambient air condition between 4.85 psia and 2.14 psia.

16. The propulsion system in accordance with one or more clauses herein, wherein the propulsion system comprises a ratio of a quantity of blades to a quantity of vanes between 2:5 and 2:1.

17. The propulsion system in accordance with one or more clauses herein, wherein the quantity of blades is between three and twenty.

18. The propulsion system in accordance with one or more clauses herein, wherein the quantity of vanes is between five and thirty.

19. The propulsion system in accordance with one or more clauses herein, wherein the rotor assembly comprises a blade pitch change mechanism configured to control blade pitch at one or more of the plurality of blades.

20. The propulsion system in accordance with one or more clauses herein, wherein the vane assembly comprises a vane pitch change mechanism configured to control vane pitch at one or more of the plurality of vanes.

21. The propulsion system in accordance with one or more clauses herein, wherein the propulsion system generates a power loading at the rotor assembly of 50 horsepower per ft² or less at cruise altitude.

22. A propulsion system, the propulsion system comprising a core engine encased in a nacelle, wherein the nacelle defines a diameter, a rotor assembly comprising a plurality of blades and a hub, a vane assembly extended from the nacelle of the core engine, the vane assembly positioned aft of the rotor assembly, the propulsion system defines a length extended from the hub of the rotor assembly to an aft end of the nacelle, and wherein a ratio of length to diameter is at least 2.

23. The propulsion system in accordance with one or more clauses herein, wherein the core engine comprises an axisymmetric inlet.

24. The propulsion system in accordance with one or more clauses herein comprising the system for reducing noise generation for a single unducted rotor engine in accordance with one or more clauses herein.

25. The propulsion system in accordance with one or more clauses herein, wherein the rotor assembly is a single unducted rotor assembly configured to provide substantially axial thrust.

26. The propulsion system in accordance with one or more clauses herein, comprising a core engine configured to produce combustion gases for driving a turbine section, wherein the variable pitch rotor assembly is configured to provide changes in thrust vector without changes in speed at the core engine.

27. The propulsion system in accordance with one or more clauses herein comprising the system for reducing noise generation for a single unducted rotor engine in accordance with one or more clauses herein.

28. The propulsion system in accordance with one or more clauses herein, wherein the rotor assembly is a single stage unducted rotor assembly configured to provide substantially axial thrust.

29. A system for reducing noise generation for a single unducted rotor engine, the system comprising the propulsion system in accordance with one or more clauses herein.

30. A propulsion system defining an engine centerline, the propulsion system comprising a rotor assembly comprising a plurality of blades extended radially relative to the engine centerline axis, and a vane assembly positioned aft of the rotor assembly, the vane assembly comprising a plurality of vanes extended radially relative to the engine centerline axis, wherein the plurality of vanes is configured to generate non-uniform characteristics relative to one another, and wherein the propulsion system comprises a ratio of a quantity of blades to a quantity of vanes between 2:5 and 2:1.

31. The propulsion system in accordance with one or more clauses herein, wherein two or more of the plurality of vanes is staggered circumferentially from one another.

32. The propulsion system in accordance with one or more clauses herein, wherein two or more of the plurality of vanes is staggered axially from one another.

33. The propulsion system in accordance with one or more clauses herein, wherein the non-uniform characteristics comprises one or more of camber, stagger, circumferential spacing, axial position, span, tip radius, or combinations thereof.

34. The propulsion system in accordance with one or more clauses herein, comprising a vane characteristics change mechanism operably connected to the plurality of vanes of the vane assembly, wherein the vane characteristics change mechanism is configured to generate non-uniform characteristics of the plurality of vanes relative to one another.

35. The propulsion system in accordance with one or more clauses herein, wherein the vane characteristics change mechanism is configured to provide two or more different vane characteristics schedules to the plurality of vanes.

36. The propulsion system in accordance with one or more clauses herein, wherein the plurality of vanes connected to the vane characteristics change mechanism is operable independent of at least one other vane.

37. The propulsion system in accordance with one or more clauses herein, the plurality of vanes comprising a first set of vanes independently changeable of a vane characteristic from a second set of vanes.

38. A propulsion system, the propulsion system comprising a rotor assembly comprising a plurality of blades, and a vane assembly positioned aft of the rotor assembly, the vane assembly comprising a plurality of vanes, and a vane characteristics change mechanism operably connected to the plurality of vanes of the vane assembly, wherein the vane characteristics change mechanism is configured to rotate one or more of the plurality of vanes along a vane pitch axis.

39. The propulsion system in accordance with one or more clauses herein, wherein the vane characteristics change mechanism is configured to generate non-uniform characteristics of the plurality of vanes relative to one another.

40. The propulsion system in accordance with one or more clauses herein, wherein the quantity of blades is 20 or fewer.

41. The propulsion system in accordance with one or more clauses herein, wherein the quantity of blades is between 16 and 11.

42. The propulsion system in accordance with one or more clauses herein, wherein a difference between the quantity of vanes and the quantity of blades is between 2 and −2.

43. The propulsion system in accordance with one or more clauses herein, wherein a difference between the quantity of vanes and the quantity of blades is between 1 and −1.

44. The propulsion system in accordance with one or more clauses herein, wherein a difference between the quantity of vanes and the quantity of blades is between 2 and −2, and wherein the quantity of blades is between 16 and 11.

45. The propulsion system in accordance with one or more clauses herein, wherein the ratio of the quantity of blades to the quantity of vanes between 0.5 and 1.5.

46. The propulsion system in accordance with one or more clauses herein, wherein a sum of blades and vanes is 30 or fewer, and wherein the sum of blades and vanes 20 or greater.

47. The propulsion system in accordance with one or more clauses herein, wherein the sum of blades and vanes is between 24 and 28.

48. The propulsion system in accordance with one or more clauses herein, wherein the sum of blades and vanes is between 25 and 27.

49. A propulsion system defining an engine centerline axis, the propulsion system including an unducted single rotor assembly comprising a plurality of blades extended radially relative to the engine centerline axis, and a vane assembly positioned aft of the unducted rotor assembly, wherein the vane assembly comprises a plurality of vanes extended radially relative to the engine centerline axis, and wherein the propulsion system comprises one or more of a ratio of a quantity of blades to a quantity of vanes between 2:5 and 2:1, a difference between the quantity of vanes and the quantity of blades is between 2 and −2, or a sum of blades and vanes between 20 and 30.

50. The propulsion system in accordance with one or more clauses herein, wherein the vane assembly includes a plurality of vanes, and wherein the plurality of vanes are configured to impart a change in tangential velocity of the air opposite to that imparted by the rotating element, and wherein the plurality of vanes have non-uniform characteristics with respect to one another and are configured to generate a desired vane exit swirl angle.

51. The propulsion system in accordance with one or more clauses herein, wherein the non-uniform characteristic is selected from the group consisting of: camber, stagger, circumferential spacing, axial position, span, tip radius, and combinations thereof.

52. The propulsion system in accordance with one or more clauses herein, wherein said vanes have a root, a tip, and a span therebetween, and wherein said non-uniform characteristic is attributed to a portion of the span of said vanes.

53. The propulsion system in accordance with one or more clauses herein, wherein said non-uniform characteristic is attributed to substantially all of the span of said vanes.

54. The propulsion system in accordance with one or more clauses herein, wherein said vanes are variable in pitch.

55. The propulsion system in accordance with one or more clauses herein, wherein said vanes are individually variable in pitch.

56. The propulsion system in accordance with one or more clauses herein, wherein a plurality of said vanes are variable in pitch in conjunction with one another.

57. The propulsion system in accordance with one or more clauses herein, the propulsion system comprising a rotating element having an axis of rotation and a stationary element, said rotating element having a plurality of blades each having a blade root proximal to said axis, a blade tip remote from said axis, and a blade span measured between said blade root and said blade tip, wherein said stationary element has a plurality of vanes, the plurality of vanes each having a vane root proximal to said axis, a vane tip remote from said axis, and a vane span measured between said vane root and said vane tip, and wherein the plurality of vanes are configured to impart a change in tangential velocity of the air opposite to that imparted by the rotating element, and wherein the plurality of vanes have non-uniform characteristics with respect to one another and are configured to generate a desired vane exit swirl angle.

58. The propulsion system in accordance with one or more clauses herein, wherein said non-uniform characteristics are tailored to accommodate the effects of an aircraft structure.

59. The propulsion system in accordance with one or more clauses herein, wherein said aircraft structure is one of a wing, a fuselage, or a pylon.

60. The propulsion system in accordance with one or more clauses herein, wherein the maximum diameter of the cowl corresponds substantially to a location or positioning of a root of a vane of the vane assembly extended from the cowl.

61. A thrust producing system comprising an aircraft structure comprising an aircraft surface, an unshrouded rotating element, a vane assembly located aft of the rotating element, wherein at least a portion of the aircraft surface is merged along an axial direction with the vane assembly.

62. The thrust producing system in accordance with one or more clauses herein, wherein the aircraft structure comprises one or more of a pylon, a fuselage, or a wing.

63. The thrust producing system in accordance with one or more clauses herein, wherein a leading edge of the aircraft structure is merged along the axial direction with the vane assembly.

64. The thrust producing system in accordance with one or more clauses herein, comprising a drive mechanism configured to provide torque and power to the unshrouded rotating element.

65. The thrust producing system in accordance with one or more clauses herein, wherein the aircraft surface and the vane assembly are together evenly spaced along the axial direction from a reference rotor plane.

66. The thrust producing system in accordance with one or more clauses herein, wherein at least the vane assembly is configured to impart a change in tangential velocity of the air opposite to that imparted by the rotating element, and wherein the vane assembly comprises non-uniform characteristics with respect to two or more vanes, and wherein the vane assembly is configured to generate a desired exit swirl angle.

67. The thrust producing system in accordance with one or more clauses herein, comprising a plurality of vanes positioned at the vane assembly and the aircraft structure, wherein at least a portion of the plurality of vanes is variable in pitch.

68. A thrust producing system comprising an aircraft structure comprising an aircraft surface positioned at one or more of a pylon, a fuselage, or a wing, an unshrouded rotating element, a drive mechanism configured to provide torque and power to the unshrouded rotating element, the drive mechanism connected to an aircraft by the aircraft structure, an unshrouded vane assembly located aft of the rotating element, wherein at least a portion of the aircraft surface is merged along an axial direction with the vane assembly, and wherein at least the portion of the aircraft surface is positioned along a circumferential direction between two vanes of the vane assembly.

69. The thrust producing system in accordance with one or more clauses herein, wherein a leading edge of the aircraft structure is merged along the axial direction with the unshrouded vane assembly.

70. The thrust producing system in accordance with one or more clauses herein, wherein the aircraft surface and the unshrouded vane assembly are together evenly spaced along the axial direction from a reference rotor plane.

71. The thrust producing system in accordance with one or more clauses herein, comprising a non-rotating stationary element positioned along the circumferential direction relative to a longitudinal axis of the thrust producing system, wherein the stationary element comprises the unshrouded vane assembly and the aircraft surface.

72. The thrust producing system in accordance with one or more clauses herein, wherein the stationary element is configured to impart a change in tangential velocity of the air opposite to that imparted by the rotating element, and wherein the unshrouded vane assembly comprises non-uniform characteristics with respect to two or more vanes, and wherein the stationary element is configured to generate a desired exit swirl angle.

73. The thrust producing system in accordance with one or more clauses herein, wherein the non-uniform characteristic is selected from the group consisting of: camber, stagger, circumferential spacing, axial position, span, tip radius, and combinations thereof.

74. The thrust producing system in accordance with one or more clauses herein, comprising a plurality of vanes positioned at the vane assembly and the aircraft surface.

75. The thrust producing system in accordance with one or more clauses herein, wherein each of the plurality of vanes comprises a leading edge.

76. The thrust producing system in accordance with one or more clauses herein, wherein at least a portion of the plurality of vanes is variable in pitch.

77. A thrust producing system for an aircraft, comprising an aircraft structure comprising a fuselage and a pylon, wherein the pylon comprises a leading edge, an unshrouded rotating element, a drive mechanism configured to provide torque and power to the unshrouded rotating element, the drive mechanism connected to an aircraft by the aircraft structure, an unshrouded vane assembly located aft of the rotating element and rotationally fixed in relation to a longitudinal axis of the drive mechanism, wherein the unshrouded vane assembly comprises a plurality of vanes positioned along a circumferential direction, and wherein at least a portion of the leading edge of the pylon is merged along an axial direction between two vanes of the unshrouded vane assembly.

78. The thrust producing system in accordance with one or more clauses herein, wherein the pylon and the unshrouded vane assembly are together evenly spaced along the axial direction from a reference rotor plane.

79. The thrust producing system in accordance with one or more clauses herein, wherein at least the unshrouded vane assembly is configured to impart a change in tangential velocity of the air opposite to that imparted by the unshrouded rotating element, and wherein the unshrouded vane assembly comprises non-uniform characteristics with respect to two or more vanes, and wherein the unshrouded vane assembly is configured to generate a desired exit swirl angle.

80. The thrust producing system in accordance with one or more clauses herein, wherein at least a portion of the plurality of vanes is variable in pitch.

81. A thrust producing system for an aircraft, the thrust producing system comprising an aircraft structure comprising a fuselage and a pylon, wherein the pylon comprises a leading edge; an unshrouded rotating element; a drive mechanism configured to provide torque and power to the unshrouded rotating element, the drive mechanism connected to an aircraft by the aircraft structure; an unshrouded vane assembly located aft of the rotating element and rotationally fixed in relation to a longitudinal axis of the drive mechanism, wherein the unshrouded vane assembly comprises a plurality of vanes positioned along a circumferential direction; and wherein at least a portion of the leading edge of the pylon is merged along an axial direction between two vanes of the unshrouded vane assembly.

82. The thrust producing system in accordance with one or more clauses herein, wherein the pylon and the unshrouded vane assembly are together evenly spaced along the axial direction from a reference rotor plane.

83. The thrust producing system in accordance with one or more clauses herein, wherein at least the unshrouded vane assembly is configured to impart a change in tangential velocity of the air opposite to that imparted by the unshrouded rotating element, and wherein the unshrouded vane assembly comprises non-uniform characteristics with respect to two or more vanes, and wherein the unshrouded vane assembly is configured to generate a desired exit swirl angle.

84. The thrust producing system in accordance with one or more clauses herein, wherein at least a portion of the plurality of vanes is variable in pitch.

85. The thrust producing system in accordance with one or more clauses herein comprising the propulsion system in accordance with one or more clauses herein.

86. The propulsion system in accordance with one or more clauses herein, wherein a circumferential spacing Q at a given reference dimension R, between neighboring vanes and related vanes, for vane counts N from about 5 to about 20, is from about 10% to about 400% of the nominal.

87. The propulsion system in accordance with one or more clauses herein, wherein an axial spacing from the rotor plane to vanes and related vanes is up to about 400% of the radial height H.

88. The thrust producing system in accordance with one or more clauses herein, wherein a circumferential spacing Q at a given reference dimension R, between neighboring vanes and related vanes, for vane counts N from about 5 to about 20, is from about 10% to about 400% of the nominal.

89. The thrust producing system in accordance with one or more clauses herein, wherein an axial spacing from the rotor plane to vanes and related vanes is up to about 400% of the radial height H.

90. The propulsion system in accordance with one or more clauses herein, wherein the ratio of length to diameter is at least 2.5.

What is claimed:

1. A propulsion system defining an engine centerline, the propulsion system comprising:
a rotor assembly comprising a plurality of blades extended radially relative to the engine centerline axis; and
a vane assembly positioned in aerodynamic relationship with the rotor assembly, wherein the vane assembly comprises a plurality of vanes extended radially relative to the engine centerline axis, and wherein the propulsion system comprises a ratio of a quantity of blades to a quantity of vanes between 2:5 and 2:1.

2. The propulsion system of claim 1, wherein the quantity of blades is 20 or fewer.

3. The propulsion system of claim 1, wherein the quantity of blades is between 16 and 11.

4. The propulsion system of claim 1, wherein a difference between the quantity of vanes and the quantity of blades is between 2 and −2.

5. The propulsion system of claim 1, wherein a difference between the quantity of vanes and the quantity of blades is between 2 and −2, and wherein the quantity of blades is between 16 and 11.

6. The propulsion system of claim 1, wherein the ratio of the quantity of blades to the quantity of vanes between 0.5 and 1.5.

7. The propulsion system of claim 1, wherein a sum of blades and vanes is 30 or fewer, and wherein the sum of blades and vanes is 20 or greater.

8. The propulsion system of claim 1, wherein the rotor assembly is unducted.

9. The propulsion system of claim 8, wherein the vane assembly is positioned aft of the rotor assembly.

10. The propulsion system of claim 1, wherein the vane assembly is unducted.

11. The propulsion system of claim 1, the propulsion system comprising:
a core engine encased in a nacelle, wherein the nacelle defines a maximum diameter, and wherein the vane assembly is extended from the nacelle.

12. The propulsion system of claim 11, wherein the rotor assembly comprises a hub from which the plurality of blades is extended, and wherein the propulsion system comprises a length extended from a forward end of the hub to an aft end of the nacelle, and wherein a ratio of length to maximum diameter is at least 2.

13. The propulsion system of claim 12, wherein the ratio of length to maximum diameter is at least 2.5.

14. The propulsion system of claim 1, wherein the core engine and the rotor assembly are together configured to generate a power loading of 25 horsepower per square foot or greater at cruise altitude.

15. The propulsion system of claim 1, wherein the rotor assembly is configured to rotate at a blade tip speed of up to 750 feet per second.

16. A propulsion system defining an engine centerline axis, the propulsion system comprising:
an unducted single rotor assembly comprising a plurality of blades extended radially relative to the engine centerline axis; and
a vane assembly positioned aft of the unducted rotor assembly, wherein the vane assembly comprises a plurality of vanes extended radially relative to the engine centerline axis, and wherein the propulsion system comprises a difference between a quantity of vanes and a quantity of blades is between 2 and −2.

17. The propulsion system of claim 16, wherein the rotor assembly comprises a blade pitch change mechanism configured to control blade pitch at one or more of the plurality of blades relative to vane pitch at one or more of the plurality of vanes.

18. The propulsion system of claim 17, wherein the vane assembly comprises a vane pitch change mechanism configured to control vane pitch at one or more of the plurality of vanes relative to blade pitch at one or more of the plurality of blades.

19. The propulsion system of claim 16, the propulsion system comprising:
a core engine encased in a nacelle, wherein the nacelle defines a maximum diameter, and wherein the vane assembly is extended from the nacelle; and
wherein the rotor assembly comprises a hub from which the plurality of blades is extended, and wherein the propulsion system comprises a length extended from a forward end of the hub to an aft end of the nacelle, and wherein a ratio of length to maximum diameter is at least 2.

20. The propulsion system of claim 16, wherein the quantity of blades is 20 or fewer.

21. The propulsion system of claim 20, wherein a sum of blades and vanes is 30 or fewer, and wherein the sum of blades and vanes is 20 or greater.

22. The propulsion system of claim 20, wherein a ratio of the quantity of blades to the quantity of vanes is between 2:5 and 2:1.
